(19) United States
(12) Patent Application Publication
(10) Pub. No.: US 2026/0261507 A1
(43) Pub. Date: Sep. 3, 2026

(54) Method for Processing SRV6 Message, and Node

(71) Applicants: China Mobile Communication Co., Ltd Research Institute, Beijing (CN); China Mobile Communications Group Co., Ltd., Beijing (CN)

(72) Inventors: Liuyan Han, Beijing (CN); Minxue Wang, Beijing (CN); Han Li, Beijing (CN); Dechao Zhang, Beijing (CN)

(21) Appl. No.: 18/866,257

(22) PCT Filed: May 16, 2023
(86) PCT No.: PCT/CN2023/094579

§ 371 Date: Nov. 15, 2024

(30) Foreign Application Priority Data
May 16, 2022 (CN) 202210529841.6

(51) Int. Cl. H04L 45/00; H04L 45/745; H04Q 11/04

(52) U.S. Cl. CPC H04L 45/34; H04L 45/745; H04Q 11/04

(57) ABSTRACT

An SRv6 message processing method includes: a first node receiving an SRv6 message, which carries a segment identifier (SID), and when the SID indicates that the first node executes a time-division multiplexing (TDM) channel function, the first node mapping the SRv6 message to a TDM channel.

### CROSS-REFERENCE TO RELATED APPLICATIONS

This application is the U.S. National Stage Application of International Application No. PCT/CN2023/094579, filed on May 16, 2023, which claims priority to Chinese Patent Application No. 202210529841.6, filed on May 16, 2022, the entire contents of which are incorporated herein by reference for all purposes.

### TECHNICAL FIELD

The disclosure relates to the field of communication technology and in particular to a method and an apparatus for processing a segment routing over internet protocol version 6 (SRv6) message, a node and a control device.

### BACKGROUND

The segment routing over internet protocol version 6 (SRv6) inherits the advantages of segment routing (SR) in head node calculation, and also have the features such as an unlimited label space, uniqueness over a whole network, and segment identity (SID) reachability over an internet protocol (IP). Furthermore, arbitrary point access and interconnection between any two nodes mat be achieved as long as the addresses are reachable. As a core technology of the next-generation IP network, the SRv6 has clearly become a direction for network evolution in the context of the 5th generation (5G) of mobile communication and the cloud era.

When the SRv6 is used in the 5G and cloud applications, many scenarios require connections from edge users to large regions (center regions). In this case, an SRv6 path includes not only a router that supports a three-layer SR but also typically needs to pass through a transport network and a device. The networks and devices include slicing packet network (SPN) devices in metropolitan areas, optical transport network (OTN) devices in backbone networks, etc.

As an IP technology, the main advantages of the SRv6 include providing low-cost, large-bandwidth, and flexible connections. In addition to supporting packet services, the transport network may also provide low-latency, hard slicing solutions based on time-division multiplexing (TDM) cross-connect technology.

The existing SRv6 technology, when passing through the transport network, there are two processing methods to ensure effective end-to-end routing. The first method is an overlay method, where the transport network operates on the SID of the SRv6, and an upper-layer SRv6 network path is not aware of a specific path and a specific configuration of the transport network. The second method is a traditional underlay method, where the same three-layer routing technology and the SRv6 label are used in the transport network and the IP. The relevant technologies are unable to effectively utilize and retain the advantages of TDM hard slicing within the transport network.

### SUMMARY

In a first aspect, a method for processing an SRv6 message is provided in the disclosure. The method includes: receiving by a first node, an SRv6 message that carries a segment identity (SID); and in response to the SID indicating the first node to perform a TDM channel function, mapping by the first node, the SRv6 message to a TDM channel.

In a second aspect, a method for processing an SRv6 message is also provided in the disclosure. The method includes: determining by a control device, an SRv6 path and an SID corresponding to the SRv6 path, in which the SRv6 path corresponds to a plurality of domains, and the SID includes SIDs respectively corresponding to the plurality of domains, in which an SID corresponding to at least one domain is capable of indicating that at least one node in the domain needs to perform a TDM channel function; and sending an SRv6 message that carries the SID to a head node of the SRv6 path.

In a third aspect, a first node is also provided in the disclosure. The first node includes a processor and a transceiver, in which the transceiver is configured to receive and send data under a control of the processor, in which the processor is configured to perform the method as described in the first aspect.

### BRIEF DESCRIPTION OF THE DRAWINGS

FIG. 1 is a first flow chart illustrating a method for processing a segment routing over internet protocol version 6 (SRv6) message according to an embodiment of the disclosure.

FIG. 2 is a block diagram illustrating a segment identity (SID) in a method for processing an SRv6 message according to an embodiment of the disclosure.

FIG. 3 is a second flow chart illustrating a method for processing an SRv6 message according to an embodiment of the disclosure.

FIG. 4 is a schematic diagram illustrating an SID generation in a method for processing an SRv6 message according to an embodiment of the disclosure.

FIG. 5 is a first block diagram illustrating an apparatus for processing an SRv6 message according to an embodiment of the disclosure.

FIG. 6 is a block diagram illustrating a first node according to an embodiment of the disclosure.

FIG. 7 is a second block diagram illustrating an apparatus for processing an SRv6 message according to an embodiment of the disclosure.

FIG. 8 is a block diagram illustrating a control device according to an embodiment of the disclosure.

### DETAILED DESCRIPTION

To clarify the technical problems to be solved, and the technical solutions and advantages of the disclosure, a detailed description in conjunction with the accompanying drawings and specific embodiments will be provided in the following.

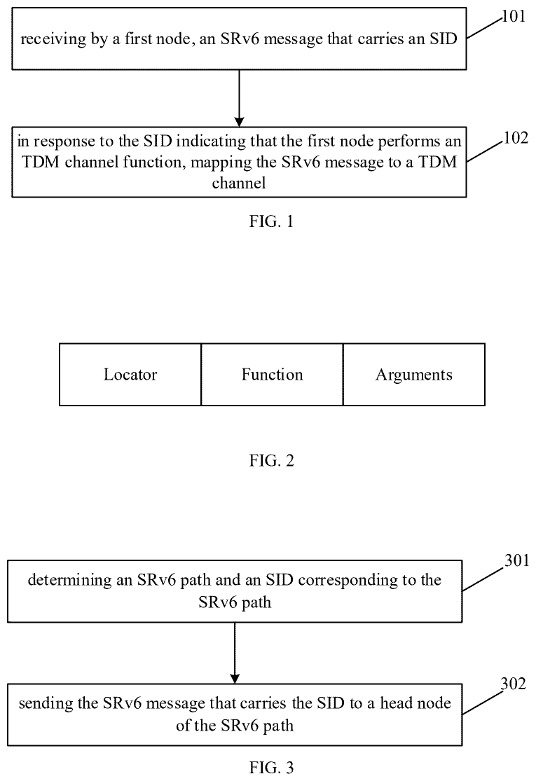

As shown in FIG. 1, a method for processing a segment routing over internet protocol version 6 (SRv6) message is provided in an embodiment of the disclosure. The method includes the following steps 101 to 102.

At step 101, the first node receives an SRv6 message that carries a segment identity (SID).

At step 102, in response to the SID indicating the first node to perform a time-division multiplexing (TDM) channel function, the SRv6 message is mapped to a TDM channel.

In the embodiments of the disclosure, the TDM channel mechanism for transmission is combined with the three-layer routing, enabling the first node to guide the SRv6 message to the TDM channel for direct TDM cross processing. This solves the problem of the TDM transmission capability being invisible to the SRv6, thus significantly enhancing the performance of the SRv6 path.

Optionally, the first node is an entry node of the TDM channel.

In an embodiment of the disclosure, in response to the SID carrying a first target value that characterizes the TDM function, it is determined that the SID indicates the first node to perform the TDM channel function.

Optionally, a format of the SID is shown in FIG. 2. The SID includes: a Locator field, a Function field, and an Arguments field. As an optional embodiment, the total length of the Locator field, the Function field, and the Arguments field is fixed (typically 128 bits), where the bit length of the Function field may vary in different scenarios.

The SID includes a first field, which may also be referred to as the Function field. The Function field carries the first target value that characterizes the TDM function. For example, the first target value is a specific value that is predefined, which is not limited herein. For example, the value of all bits or the value of a part of the bits of the Function field is the first target value.

Optionally, the SID includes a second field, which may also be referred to as the Arguments field. The second field carries TDM Arguments in response to the first field carrying the first target value. The TDM arguments include at least one of: type information of the TDM channel, such as a metro transport network (MTN), a synchronous digital hierarchy (SDH), an optical transport network (OTN), and etc.; or information capable of indicating a specific TDM channel.

The information capable of indicating the specific TDM channel includes at least one of: identity (ID) information of the TDM channel, such as an ID of the TDM channel assigned by the control and management system; slot information used by the TDM channel, which may correspond to a specific TDM channel; or a client ID, which may correspond to a specific TDM channel being used.

In another optional embodiment of the disclosure, the method further includes: in response to a value of the SID being a second target value, determining that the SID indicates the first node to perform the TDM channel function; in which the second target value corresponds to information capable of indicating a specific TDM channel.

It should be noted that the value of the SID may be understood as the overall value of the SID. The second target value is a predefined value, and each second target value corresponds to the information capable of indicating a specific TDM channel respectively. Optionally, the second target value may be a single predefined value or a plurality of predefined values, which is not limited herein.

Optionally, different second target values may correspond directly to different TDM channels. For example, different SID values can be used to differentiate the different TDM channels. When the SID is received by the first node, the first node, based on the value of the SID, determines the TDM channel corresponding to the value of the SID by querying a local table, and then maps the SRv6 message to the determined TDM channel.

Optionally, if the SID is received by the first node and it is determined by querying the local table that no information of the TDM channel corresponding to the value of the SID exists in the local table, it is determined that the SID does not indicate the first node to perform the TDM channel function. In this case, after performing an SID pointer adjustment for the SRv6, the first node sends the SRv6 message to a next-hop node of an SRv6 path.

In at least one optional embodiment of the disclosure, the SID further includes a third field, which may also be referred to as the Locator field. The third field indicates addressing and forwarding of the SRv6 message. For example, the Locator field carries IP address information of each SRv6 node on the SRv6 path, and each node that has received the SRv6 message may determine whether the SRv6 message is a message sent to the node based on the Locator field.

Accordingly, in an embodiment of the disclosure, before mapping the SRv6 message to the TDM channel by the first node, the method further includes: determining, based on the third field of the SID, that the SID is a label that the first node needs to perform. That is, the first node that has received the SRv6 message determines, based on the third field of the SID, whether or not the SRv6 message is a message sent to the first node. In response to determining that the SRv6 message is the message sent to the first node, the first node determines that the SID is a label that the first node needs to perform.

Optionally, when the first node has received the SRv6 message that carries the SID and has determined through the Locator field that the SID is the label that the first node needs to perform, the node directly maps the SRv6 message to a payload of the TDM channel, if the Function field in the SID carries the first target value that characterizes the TDM function, or if the value of the SID is the second target value.

In at least one optional embodiment of the disclosure, an intermediate node in the TDM channel does not perform an SRv6 message header processing of the SRv6 message transmitted in the TDM channel, and directly performs a TDM channel cross processing on the SRv6 message transmitted in the TDM channel.

The SRv6 message header of the SRv6 message is invisible to the intermediate node in the TDM channel. Thus, the intermediate node in the TDM channel does not perform an SRv6 message header processing of the SRv6 message transmitted in the TDM channel, and directly performs a TDM channel cross processing on the SRv6 message transmitted in the TDM channel.

In at least one optional embodiment of the disclosure, in response to an exit node of the TDM channel not being an end node in the SRv6 path corresponding to the SRv6 message, the exit node of the TDM channel sends the SRv6 message to a next-hop node of an SRv6 path, after performing an SID pointer adjustment for the SRv6 (e.g., the segments left field).

In embodiments of the disclosure, the SID carried by the SRv6 message indicates that the corresponding node needs to perform the TDM channel function. This enables the node that has received the SRv6 message maps the SRv6 message to the TDM channel for TDM cross processing, which solves the problem of the TDM transmission capability being invisible to the SRv6 in the existing SRv6 message transmission, and thus significantly enhance the performance of the SRv6 path.

As shown in FIG. 3, a method for processing an SRv6 message, performed by a control device, is also provided in an embodiment of the disclosure. The method includes the following steps 301 to 302.

At step 301, a control device determines an SRv6 path and an SID corresponding to the SRv6 path, in which the SRv6 path corresponds to a plurality of domains, and the SID includes SIDs respectively corresponding to the plurality of domains, in which an SID corresponding to at least one domain is capable of indicating that at least one node in the domain needs to perform an TDM channel function.

At step 302, the SRv6 message that carries the SID is sent to a head node of the SRv6 path.

Optionally, the control device may be referred to as an orchestrator.

As an optional embodiment, the method further includes: receiving capability information sent by at least one domain controller, in which the capability information indicates that a domain corresponding to the domain controller possesses a TDM channel capability.

The step 301 includes: determining, based on the capability information and a transmission requirement, the SRv6 path and an SID corresponding to each domain, in which an SID corresponding to the at least one node in the domain that possesses the TDM channel capability carries a first target value that characterizes the TDM channel function, or a value of an SID corresponding to the at least one node in the domain that possesses the TDM channel capability is a second target value; and determining, based on the SID corresponding to each domain, the SID corresponding to the SRv6 path, in which the second target value corresponds to information capable of indicating a specific TDM channel.

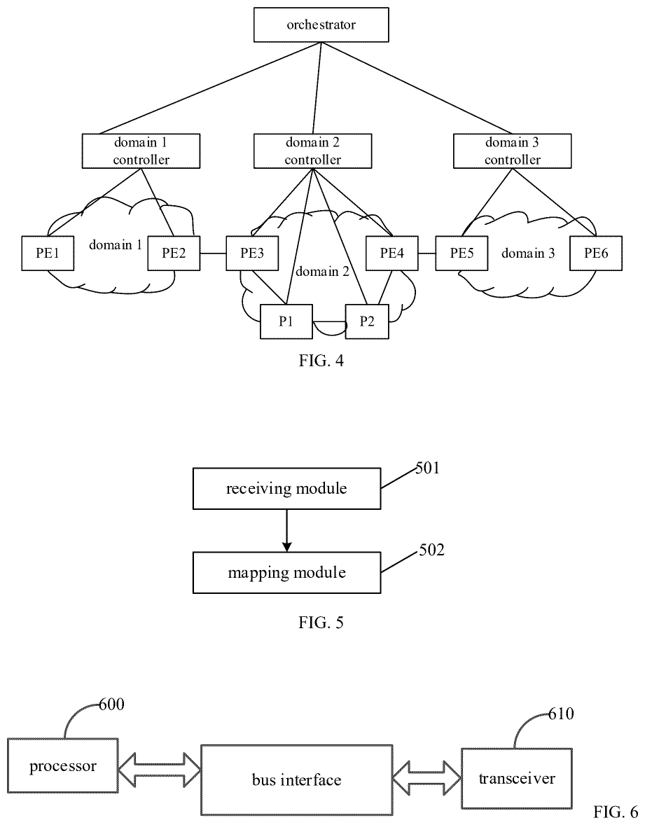

For example, as shown in FIG. 4, the domain 2 has a TDM cross capability and can report such capability to the orchestrator. The orchestrator calculates a forwarding path based on the requirement and generates an SID. In this case, in scenarios where there is a requirement, the orchestrator may enable the first target value that characterizes the TDM function is carried in the SID corresponding to the domain 2, or may assign the SID value (i.e., the second target value) that characterizes the TDM function to the domain 2, and send the SID of the entire path to the first node (e.g., PE1).

As another optional embodiment, the method further includes: receiving SIDs corresponding to domains sent by a plurality of domain controllers, in which an SID corresponding to the at least one node in the domain that possesses the TDM channel capability carries a first target value that characterizes the TDM channel function, or a value of an SID corresponding to the at least one node in the domain that possesses the TDM channel capability is a second target value; and determining, based on an SID corresponding to each domain, the SID corresponding to the SRv6 path, in which the second target value corresponds to information capable of indicating a specific TDM channel.

For example, as shown in FIG. 4, the domain 2 has a TDM cross capability. The domain 2 controller supports based on the requirement that, the first target value that characterizes the TDM function carried in the SID, or the SID value (i.e., the second target value) that characterizes the TDM function is assigned to the domain 2. That is, each domain controller generates an SID value and reports the SID value to the orchestrator. Then, the orchestrator forms the SID for the whole path and sends it to the first node (e.g., PE1).

In embodiments of the disclosure, the SID carried by the SRv6 message indicates that the corresponding node needs to perform the TDM channel function. This enables the node that has received the SRv6 message maps the SRv6 message to the TDM channel for TDM cross processing, which solves the problem of the TDM transmission capability being invisible to the SRv6 in the existing SRv6 message transmission, and thus significantly enhance the performance of the SRv6 path.

As shown in FIG. 5, an apparatus for processing an SRv6 message, applied to a first node, is also provided in an embodiment of the disclosure. The apparatus includes a receiving module 501 and a mapping module 502.

The receiving module 501 is configured to receive an SRv6 message that carries an SID.

The mapping module 502 is configured to, in response to the SID indicating the first node to perform a TDM channel function, map the SRv6 message to a TDM channel.

In embodiments of the disclosure, the SID carried by the SRv6 message indicates that the corresponding node needs to perform the TDM channel function. This enables the node that has received the SRv6 message maps the SRv6 message to the TDM channel for TDM cross processing, which solves the problem of the TDM transmission capability being invisible to the SRv6 in the existing SRv6 message transmission, and thus significantly enhance the performance of the SRv6 path.

It should be noted that the apparatus for processing an SRv6 message provided in the embodiments of the disclosure is an apparatus capable of implementing the method for processing an SRv6 message. Thus, all embodiments of the method for processing an SRv6 message are applicable to the apparatus and can achieve the same or similar beneficial effects.

As shown in FIG. 6, a first node is also provided in an embodiment of the disclosure. The first node includes a processor 600 and a transceiver 610.

The transceiver 610 is configured to receive and send data under a control of the processor 600.

The processor 600 is configured to receive an SRv6 message that carries an SID; and in response to the SID indicating the first node to perform a TDM channel function, map the SRv6 message to a TDM channel.

As an optional embodiment, the processor 600 is further configured to, in response to the SID carrying a first target value that characterizes the TDM function, determine that the SID indicates the first node to perform the TDM channel function.

As an optional embodiment, the processor 600 is further configured to, in response to a value of the SID being a second target value, determine that the SID indicates the first node to perform the TDM channel function; in which the second target value corresponds to information capable of indicating a specific TDM channel.

As an optional embodiment, the SID includes a first field, in which the first field carries the first target value that characterizes the TDM function.

As an optional embodiment, the SID further includes a second field. The second field carries TDM arguments. The TDM arguments include at least one of: type information of the TDM channel; or information capable of indicating a specific TDM channel.

As an optional embodiment, the information capable of indicating the specific TDM channel includes at least one of: ID information of the TDM channel; slot information used by the TDM channel; or a client ID.

As an optional embodiment, the SID further includes a third field, in which the third field indicates addressing and forwarding of an SRv6 message.

The processor is further configured to determine, based on the third field of the SID, that the SID is a label that the first node needs to perform.

As an optional embodiment, an intermediate node in the TDM channel does not perform an SRv6 message header processing of the SRv6 message transmitted in the TDM channel, and directly performs a TDM channel cross processing on the SRv6 message transmitted in the TDM channel.

As an optional embodiment, after performing an SID pointer adjustment for the SRv6, an exit node of the TDM channel sends the SRv6 message to a next-hop node of an SRv6 path.

In embodiments of the disclosure, the SID carried by the SRv6 message indicates that the corresponding node needs to perform the TDM channel function. This enables the node that has received the SRv6 message maps the SRv6 message to the TDM channel for TDM cross processing, which solves the problem of the TDM transmission capability being invisible to the SRv6 in the existing SRv6 message transmission, and thus significantly enhance the performance of the SRv6 path.

It should be noted that the first node provided in the embodiments of the disclosure is a node capable of implementing the method for processing an SRv6 message. Thus, all embodiments of the method for processing an SRv6 message are applicable to the node and can achieve the same or similar beneficial effects.

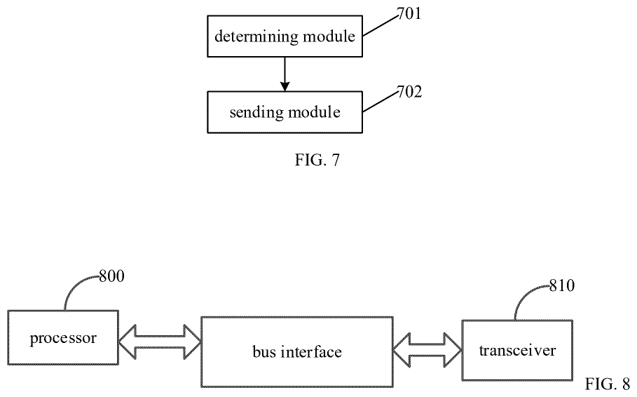

As shown in FIG. 7, an apparatus for processing an SRv6 message, applied to a control device, is also provided in an embodiment of the disclosure. The apparatus includes a determining module 701 and a sending module 702.

The determining module 701 is configured to determine an SRv6 path and an SID corresponding to the SRv6 path, in which the SRv6 path corresponds to a plurality of domains, and the SID includes SIDs respectively corresponding to the plurality of domains, in which an SID corresponding to at least one domain is capable of indicating that at least one node in the domain needs to perform an TDM channel function.

The sending module 702 is configured to send the SRv6 message that carries the SID to a head node of the SRv6 path.

In embodiments of the disclosure, the SID carried by the SRv6 message indicates that the corresponding node needs to perform the TDM channel function. This enables the node that has received the SRv6 message maps the SRv6 message to the TDM channel for TDM cross processing, which solves the problem of the TDM transmission capability being invisible to the SRv6 in the existing SRv6 message transmission, and thus significantly enhance the performance of the SRv6 path.

It should be noted that the apparatus for processing an SRv6 message provided in the embodiments of the disclosure is an apparatus capable of implementing the method for processing an SRv6 message. Thus, all embodiments of the method for processing an SRv6 message are applicable to the apparatus and can achieve the same or similar beneficial effects.

As shown in FIG. 8, a control device is also provided in an embodiment of the disclosure. The control device includes a processor 800 and a transceiver 810.

The transceiver 810 is configured to receive and send data under a control of the processor 800.

The processor 800 is configured to determine an SRv6 path and an SID corresponding to the SRv6 path, in which the SRv6 path corresponds to a plurality of domains, and the SID includes SIDs respectively corresponding to the plurality of domains, in which an SID corresponding to at least one domain is capable of indicating that at least one node in the domain needs to perform an TDM channel function; and send the SRv6 message that carries the SID to a head node of the SRv6 path.

As an optional embodiment, the processor 800 is further configured to receive capability information sent by at least one domain controller, in which the capability information indicates that a domain corresponding to the domain controller possesses a TDM channel capability; determine, based on the capability information and a transmission requirement, the SRv6 path and an SID corresponding to each domain, in which an SID corresponding to the at least one node in the domain that possesses the TDM channel capability carries a first target value that characterizes the TDM channel function, or a value of an SID corresponding to the at least one node in the domain that possesses the TDM channel capability is a second target value; and determine, based on the SID corresponding to each domain, the SID corresponding to the SRv6 path, in which the second target value corresponds to information capable of indicating a specific TDM channel.

As an optional embodiment, the processor 800 is further configured to receive SIDs corresponding to domains sent by a plurality of domain controllers, in which an SID corresponding to the at least one node in the domain that possesses the TDM channel capability carries a first target value that characterizes the TDM channel function, or a value of an SID corresponding to the at least one node in the domain that possesses the TDM channel capability is a second target value; and determine, based on an SID corresponding to each domain, the SID corresponding to the SRv6 path, in which the second target value corresponds to information capable of indicating a specific TDM channel.

In embodiments of the disclosure, the SID carried by the SRv6 message indicates that the corresponding node needs to perform the TDM channel function. This enables the node that has received the SRv6 message maps the SRv6 message to the TDM channel for TDM cross processing, which solves the problem of the TDM transmission capability being invisible to the SRv6 in the existing SRv6 message transmission, and thus significantly enhance the performance of the SRv6 path.

It should be noted that the control device provided in the embodiments of the disclosure is a control device capable of implementing the method for processing an SRv6 message. Thus, all embodiments of the method for processing an SRv6 message are applicable to the control device and can achieve the same or similar beneficial effects.

A communication device is also provided in an embodiment of the disclosure. The communication device is a first node or a control device, including a processor, and a memory storing a computer program executable by the processor. When the computer program is executed by the processor, each process in the embodiments of the method for processing an SRv6 message is implemented, and the same technical effect can be achieved, which will not be repeated herein.

A computer-readable storage medium is also provided in an embodiment of the disclosure. The computer-readable storage medium having stored a computer program that, when executed by a processor, implements each process in the embodiments of the method for processing an SRv6 message and achieves the same technical effect, which will not be repeated herein. The computer-readable storage medium includes a read-only memory (ROM), a random-access memory (RAM), a magnetic disk, or a CD-ROM, etc.

Those skilled in the art should understand that the embodiments of the present disclosure may be provided as a method, a system, or a computer program product. Thus, the present disclosure may take the form of an entirely hardware embodiment, an entirely software embodiment, or embodiments combining both software and hardware. Moreover, the present disclosure may take the form of a computer program product implemented by one or more computer-readable storage media (including but not limited to a disk memory and an optical memory, etc.), including computer-usable program code(s).

The present disclosure is described according to a flowchart and/or block diagram of a method, a device (system), and a computer program product according to the embodiments of the present disclosure. It should be understood that each process and/or block in the flowchart and/or block diagram, and a combination of a process and/or block in in the flowchart and/or a block diagram may be implemented by computer program instructions. These computer program instructions may be provided to a processor of a general-purpose computer, a special purpose computer, an embedded processor, or other programmable data processing device to generate a machine, such that when instructions are executed by the processor of the computer or other programmable data processing device, an apparatus for implementing a function specified in one or more processes in the flowchart and/or one or more blocks in the block diagram is generated.

These computer program instructions may also be stored in a computer-readable memory that can direct a computer or other programmable data processing device to operate in a particular manner, such that the instructions stored in the computer-readable memory produce a product that includes an instruction device that implements a function specified in one or more processes in the flowchart and/or one or more blocks in the block diagram.

These computer program instructions may also be loaded into a computer or other programmable data processing device, such that a series of operational steps are performed on the device to produce a computer-implemented process. In this case, the instructions are executed on a computer or other programmable device so as to implement the steps specified in one or more processes in the flowchart and/or one or more blocks in the block diagram.

The above description constitutes the preferred embodiments of the disclosure. It should be noted that, for those skilled in the art, several modifications and refinements can be made without departing from the principles described in this disclosure. These modifications and refinements should also be considered within the scope of protection of this disclosure.

1. A method for processing a segment routing over internet protocol version 6 (SRv6) message, comprising:
receiving by a first node, an SRv6 message that carries a segment identity (SID); and
in response to the SID indicating the first node to perform a time-division multiplexing (TDM) channel function, mapping by the first node, the SRv6 message to a TDM channel.

2. The method according to claim 1, further comprising:
in response to the SID carrying a first target value that characterizes the TDM channel function, determining that the SID indicates the first node to perform the TDM channel function.

3. The method according to claim 1, further comprising:
in response to a value of the SID being a second target value, determining that the SID indicates the first node to perform the TDM channel function;
wherein the second target value corresponds to information capable of indicating a specific TDM channel.

4. The method according to claim 2, wherein the SID comprises a first field, wherein the first field carries the first target value that characterizes the TDM channel function; and
wherein the SID further comprises a second field, wherein the second field carries TDM arguments;
wherein the TDM arguments comprise at least one of:
type information of the TDM channel; or
information capable of indicating a specific TDM channel, wherein the information capable of indicating the specific TDM channel comprises at least one of: identity (ID) information of the TDM channel; slot information used by the TDM channel; or a client ID.

5. (canceled)

6. The method according to claim wherein the information capable of indicating the specific TDM channel comprises at least one of:
identity (ID) information of the TDM channel;
slot information used by the TDM channel; or
a client ID.

7. The method according to claim 2, wherein the SID further comprises a third field, wherein the third field indicates addressing and forwarding of the SRv6 message;
before mapping the SRv6 message to the TDM channel by the first node, the method further comprises:
determining, based on the third field of the SID, that the SID is a label that the first node needs to perform.

8. The method according to claim 1, wherein an intermediate node in the TDM channel does not perform an SRv6 message header processing of the SRv6 message transmitted in the TDM channel, and directly performs a TDM channel cross processing on the SRv6 message transmitted in the TDM channel.

9. The method according to claim 1, wherein after performing an SID pointer adjustment for the SRv6, an exit node of the TDM channel sends the SRv6 message to a next-hop node in an SRv6 path.

10. A method for processing a segment routing over internet protocol version 6 (SRv6) message, comprising:
determining by a control device, an SRv6 path and a target segment identity (SID) corresponding to the SRv6 path, wherein the SRv6 path corresponds to a plurality of domains, and the target SID comprises a plurality of SIDs respectively corresponding to the plurality of domains, wherein an SID corresponding to each domain is capable of indicating that at least one node in the domain needs to perform a time-division multiplexing (TDM) channel function; and
sending an SRv6 message that carries the target SID to a head node of the SRv6 path.

11. The method according to claim 10, further comprising:
receiving capability information sent by at least one domain controller, wherein the capability information corresponding to each domain controller indicates that a domain corresponding to the domain controller possesses a TDM channel capability;
wherein determining the SRv6 path and the SID corresponding to the target SRv6 path comprises:
determining, based on the capability information corresponding to each domain controller and a transmission requirement, the SRv6 path and an SID corresponding to each domain, wherein an SID corresponding to the at least one node in the domain that possesses the TDM channel capability carries a first target value that characterizes the TDM channel function, or a value of an SID corresponding to the at least one node in the domain that possesses the TDM channel capability is a second target value; and
determining, based on the SID corresponding to each domain, the target SID corresponding to the SRv6 path, wherein the second target value corresponds to information capable of indicating a specific TDM channel.

12. The method according to claim 10, further comprising:
receiving a plurality of SIDs corresponding to a plurality of domains sent by a plurality of domain controllers, wherein an SID corresponding to the at least one node in the domain that possesses the TDM channel capability carries a first target value that characterizes the TDM channel function, or a value of an SID corresponding to the at least one node in the domain that possesses the TDM channel capability is a second target value; and
determining, based on an SID corresponding to each domain, the target SID corresponding to the SRv6 path, wherein the second target value corresponds to information capable of indicating a specific TDM channel.

13. (canceled)

14. A first node, comprising a processor and a transceiver, wherein the transceiver is configured to receive and send data under a control of the processor, wherein the processor is configured to:
receive a segment routing over internet protocol version 6 (SRv6) message that carries a segment identity (SID); and
in response to the SID indicating the first node to perform a time-division multiplexing (TDM) channel function, map the SRv6 message to a TDM channel.

15. The first node according to claim 14, wherein the processor is further configured to:
in response to the SID carrying a first target value that characterizes the TDM channel function, determine that the SID indicates the first node to perform the TDM channel function.

16. The first node according to claim 14, wherein the processor is further configured to:
in response to a value of the SID being a second target value, determine that the SID indicates the first node to perform the TDM channel function;
wherein the second target value corresponds to information capable of indicating a specific TDM channel.

17. The first node according to claim 15, wherein the SID comprises a first field, wherein the first field carries the first target value that characterizes the TDM channel function; and
wherein the SID further comprises a second field; wherein the second field carries TDM arguments;
wherein the TDM arguments comprise at least one of:
type information of the TDM channel; or
information capable of indicating a specific TDM channel.

18. (canceled)

19. The first node according to claim 16, wherein the information capable of indicating the specific TDM channel comprises at least one of:
identity (ID) information of the TDM channel;
slot information used by the TDM channel; or
a client ID.

20. The first node according to claim 15, or wherein the SID further comprises a third field, wherein the third field indicates addressing and forwarding of the SRv6 message;
wherein the processor is further configured to:
determine, based on the third field of the SID, that the SID is a label that the first node needs to perform.

21. The first node according to claim 14, wherein an intermediate node in the TDM channel does not perform an SRv6 message header processing of the SRv6 message transmitted in the TDM channel, and directly performs a TDM channel cross processing on the SRv6 message transmitted in the TDM channel.

22. The first node according to claim 14, wherein after performing an SID pointer adjustment for the SRv6, an exit node of the TDM channel sends the SRv6 message to a next-hop node in an SRv6 path.

23. (canceled)

24. A control device, comprising a processor and a transceiver, wherein the transceiver is configured to receive and send data under a control of the processor, wherein the processor is configured to perform the method according to claim 10.

25. (canceled)

26. (canceled)

27. (canceled)

28. (canceled)
